(19) United States
(12) Patent Application Publication
(10) Pub. No.: US 2004/0251658 A1
(43) Pub. Date: Dec. 16, 2004

(54) Motorized wheelchair trailer

(76) Inventor: Fred Hagan, Lockhart, TX (US)

Correspondence Address: Derek R. Van Gilder, 916 Main Street, Bastrop, TX, 78602, US

(21) Appl. No.: 10/461,693

(22) Filed: Jun. 13, 2003

(51) Int. Cl. B62D 53/06

(52) U.S. Cl. 280/424

(57) ABSTRACT

A motorized-wheelchair trailer has a trailer chassis (1) with two wheels (2) for trailing behind a four-wheel or three-wheel motorized wheelchair trailer (4). A first coupling member (6) is on a tow bar (7) at a tow-directional distance behind rear wheels (9) of the motorized wheelchair and a second coupling member (8) is on a trailer tongue (3) at a tow-follower distance ahead of the two trailer wheels for providing predetermined turn-directional towing of the trailer chassis. The two wheels can be on fixed axles (10) for fixed turn-directional towing or on steerable trailer axles (11) for steerable turn-directional towing. The trailer chassis is built to carry weight that is towable by the motorized wheelchair. The trailer chassis can have a passenger seat (17) to carry a passenger and/or cargo space to carry shopping, luggage and other items selectively.

### BACKGROUND OF THE INVENTION

1. Field of the Invention.

This invention relates to trailers for motorized wheelchairs.

2. Relation to prior art.

Motorized-wheelchair users often have a need or desire to carry another person or items having person-equivalent weight with them. The other person might be another incapacitated or at least partly incapacitated associate, spouse or family member who also needs or desires wheelchair assistance. For this purpose, a two-person wheelchair would be desirable, but would be quite big and bulky for most uses of motorized wheelchairs. A light, temporary, as-needed two-person capacity for a wheelchair is desirable. One known solution has included a platform on caster wheels for a second person to stand on or for carrying items behind the wheelchair as described in U.S. Pat. No. 5,927,730 granted to Sattler on Jul. 27, 1999. The Sattler patent, however, was limited to a passenger who could stand on the platform. Also, the platform increased overall length of the motorized wheelchair with resulting problems for turning in limited areas such as in aisles in stores, among furniture in homes and in elevators in buildings. The purpose of this invention is to solve the two-person-capacity problem of motorized wheelchairs.

Listed below for consideration is representative known related prior art:

| Patent Number | Date | Inventor |
|---|---|---|
| U.S. 5,927,730 | July 1999 | Sattler |
| U.S. 4,666,008 | May 1987 | Shepard et al. |
| U.S. 4,119,331 | October 1978 | Jackson |
| U.S. 3,485,314 | December 1969 | Herr |

### SUMMARY OF THE INVENTION

Objects of patentable novelty and utility taught by this invention are to provide a motorized-wheelchair trailer which:

allows two-person use of single-person motorized wheelchairs conveniently and easily as and when needed;

can carry a second passenger who also might need or desire wheelchair assistance;

allows a wheelchair user to carry a helper, assistant or companion with them;

expands use of motorized wheelchairs for shopping and more everyday activities; increases opportunities of wheelchair-bound people; and

can turn without difficulty in tight areas that include store aisles and rooms with furniture.

This invention accomplishes these and other objectives with a motorized-wheelchair trailer having two wheels on a trailer chassis that trails behind a four-wheel or three-wheel motorized wheelchair. A first coupling member is on a tow bar at a tow-directional distance behind rear wheels of the motorized wheelchair and a second coupling member is on a trailer tongue at a tow-follower distance ahead of the two trailer wheels for providing predetermined turn-directional towing of the trailer chassis. Turn-directional towing can be steerable with a steering pivoter for trailer wheels on steerable axles or fixed for trailer wheels on fixed axles. The trailer chassis is built to carry weight that is towable by the motorized wheelchair. The trailer chassis can have a passenger seat to carry a passenger and/or cargo space to carry shopping, luggage and other items selectively.

### BRIEF DESCRIPTION OF DRAWINGS

This invention is described by appended claims in relation to description of a preferred embodiment with reference to the following drawings which are explained briefly as follows:

FIG. 1 is a side elevation view of a motorized-wheelchair trailer hitched to a motorized wheelchair with a trailer tongue being longer than a tow bar and with trailer wheels on fixed axles;

FIG. 2 is a top view of the FIG. 1 illustration with the trailer chassis being in a straight line behind the motorized wheelchair;

FIG. 3 is a top view of the FIG. 2 illustration with the trailer chassis being at a turn angle behind the motorized wheelchair;

FIG. 4 is a top view of the FIG. 3 illustration with the trailer tongue having a length approximately equal to a length of the tow bar;

FIG. 5 is a top view of the FIG. 3 illustration with the trailer tongue having a length shorter than a length of the tow bar;

FIG. 6 is a top view of the motorized-wheelchair trailer hitched to the motorized wheelchair at a turn angle with a trailer tongue being longer than a tow bar and with trailer wheels being on steerable axles;

FIG. 7 is a top view of the motorized-wheelchair trailer hitched to the motorized wheelchair at a turn angle with a trailer tongue being approximately equal to a length of a tow bar and with trailer wheels being on steerable axles;

FIG. 8 is a top view of a short, arcuate-front motorized-wheelchair trailer hitched to the motorized wheelchair at a turn angle with a trailer tongue being longer than a length of a tow bar and with trailer wheels being on steerable axles;

FIG. 9 is a top view of the short, arcuate-front motorized-wheelchair trailer hitched to the motorized wheelchair at a turn angle with a trailer tongue being longer than a length of a tow bar and with trailer wheels being on fixed axles;

FIG. 10 is a side elevation view of the motorized-wheelchair trailer hitched to the motorized wheelchair with the trailer tongue having a length equal to a length of the tow bar that is vertically pivotal on the motorized wheelchair and has a coupling caster wheel at a hitch coupling;

FIG. 11 is a partially cutaway top view of the motorized-wheelchair trailer hitched to the motorized wheelchair at a turn angle with a trailer tongue being longer than a tow bar and with trailer wheels being on steerable axles that are steerable with chassis handlebars and optional computer-controlled steering motorization; and

FIG. 12 is a partially cutaway top view of the FIG. 11 illustration with the arcuate front on a short trailer chassis.

### DESCRIPTION OF PREFERRED EMBODIMENT

Listed numerically below with reference to the drawings are terms used to describe features of this invention. These terms and numbers assigned to them designate the same features throughout this description.

1. Trailer chassis 14. Vertically pivotal connector

2. Trailer wheels 15. Hitch coupling

3. Trailer tongue 16. Coupling caster wheel

4. Motorized-wheelchair trailer 17. Passenger seat

5. Motorized wheelchair 18. Foot support

6. First coupling member 19. Steering column

7. Tow bar 20. Steering rod

8. Second coupling member 21. Handlebars

9. Rear wheels 22. Steering motor

10. Fixed axles 23. Wheelchair steerer

11. Steerable axles 24. Steering computer

12. Chassis pivot base 25. Arcuate front

13. Steering pivoter 26. Down-pressure spring

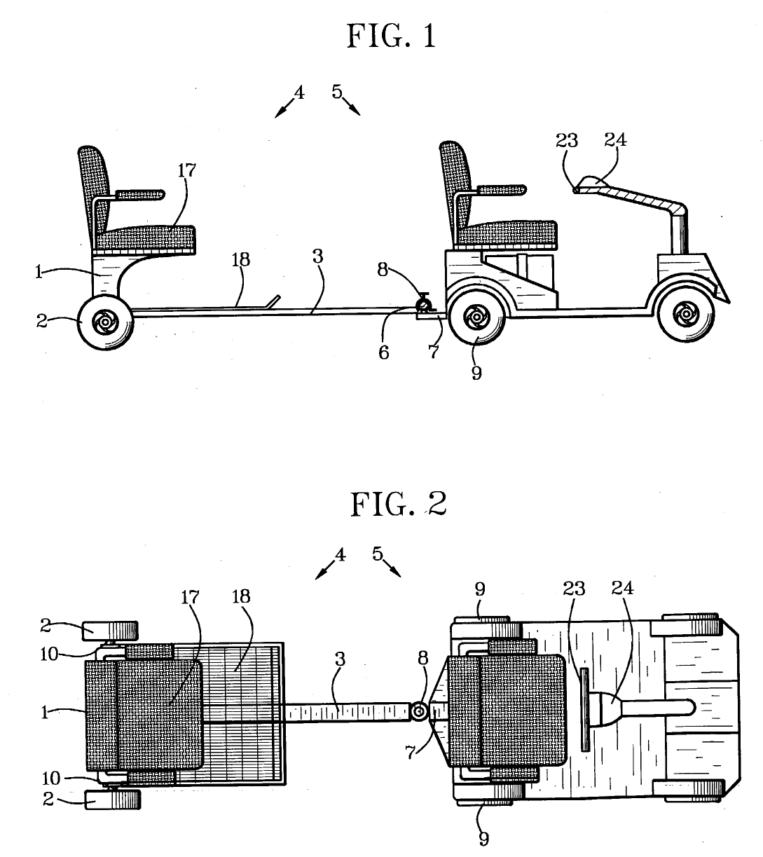

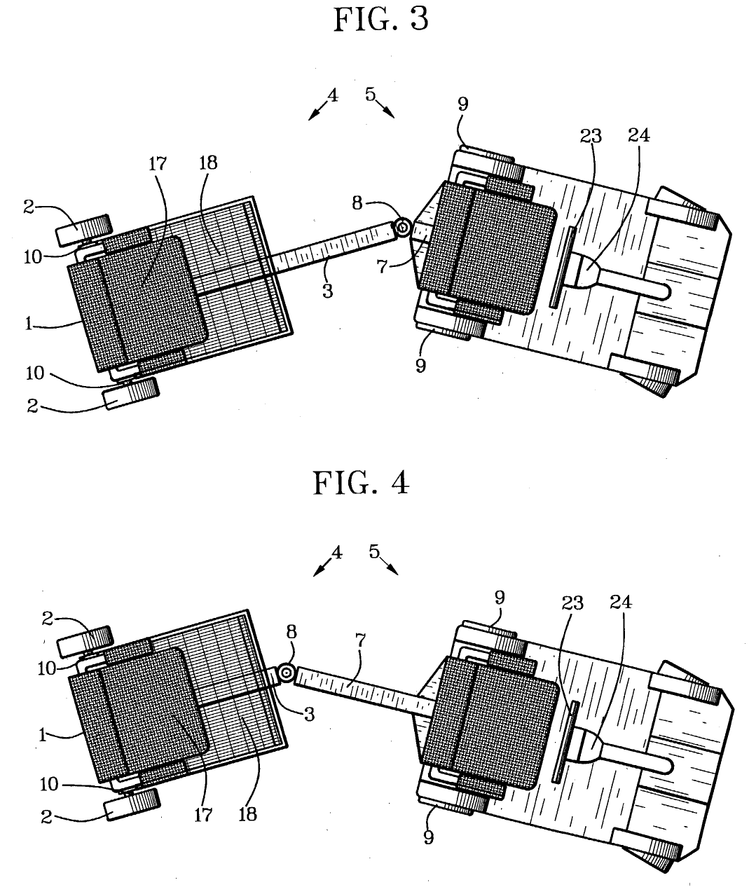

Referring to FIGS. 1-5, the motorized-wheelchair trailer includes a trailer chassis 1 having trailer wheels 2 that are oppositely disposed proximate opposite sides of the trailer chassis 1. A trailer tongue 3 is affixed to the trailer chassis 1 and extended orthogonally from proximate an axis of the trailer wheels 2. The trailer tongue 3 is articulated for pulling of the motorized-wheelchair trailer 4 by a predetermined motorized wheelchair 5. The motorized-wheelchair trailer 4 has a loaded gross weight that is towable by the motorized wheelchair 5.

A first coupling member 6 on a tow bar 7 is attachable to a rear portion of the motorized wheelchair 5. A second coupling member 8 is affixed to a front portion of the trailer tongue 3.

The first coupling member 6 and the second coupling member 8 are articulated for predeterminedly universal pivotal coupling of the trailer tongue 3 to the tow bar 7 detachably.

The first coupling member 6 is positioned on the tow bar 7 at a tow-directional distance from a trailer side of rear wheels 9 of the motorized wheelchair 5 and the second coupling member 8 is positioned on the trailer tongue 3 at a tow-follower distance from a motorized-wheelchair side of the axis of the trailer wheels 2.

The trailer wheels 2 can be rotational on axles that include fixed axles 10 having fixed perpendicularity to an axis of the trailer tongue 3. As shown in FIGS. 1-3, the tow-directional distance of the first coupling member 6 from the trailer side of the rear wheels 9 of the motorized wheel chair 5 can be predeterminedly shorter than the tow-follower distance of the second coupling member 8 from the motorized-wheelchair side of the axis of the trailer wheels 2 for turn-directional following of rear wheels 9 by the trailer wheels 2 predeterminedly. A longer tow-directional distance than tow-follower distance causes the trailer wheels 2 to “cut corners” like a long tractor-trailer instead of following the rear wheels 9 precisely.

As shown in FIG. 4, with the trailer wheels 2 rotational on axles that include fixed axles 10 having fixed perpendicularity to the axis of the trailer tongue 3, the tow-directional distance of the first coupling member 6 from the trailer side of the rear wheels 9 of the motorized wheel chair 5 can be approximately equal to the tow-follower distance of the second coupling member 8 from the motorized-wheelchair side of the axis of the trailer wheels 2 for approximately direct following of the rear wheels 9 by the trailer wheels 2. This avoids cutting corners by the trailer chassis 1. It won't knock over furniture or run into objects on the turn side that the motorized wheelchair 5 does not encounter.

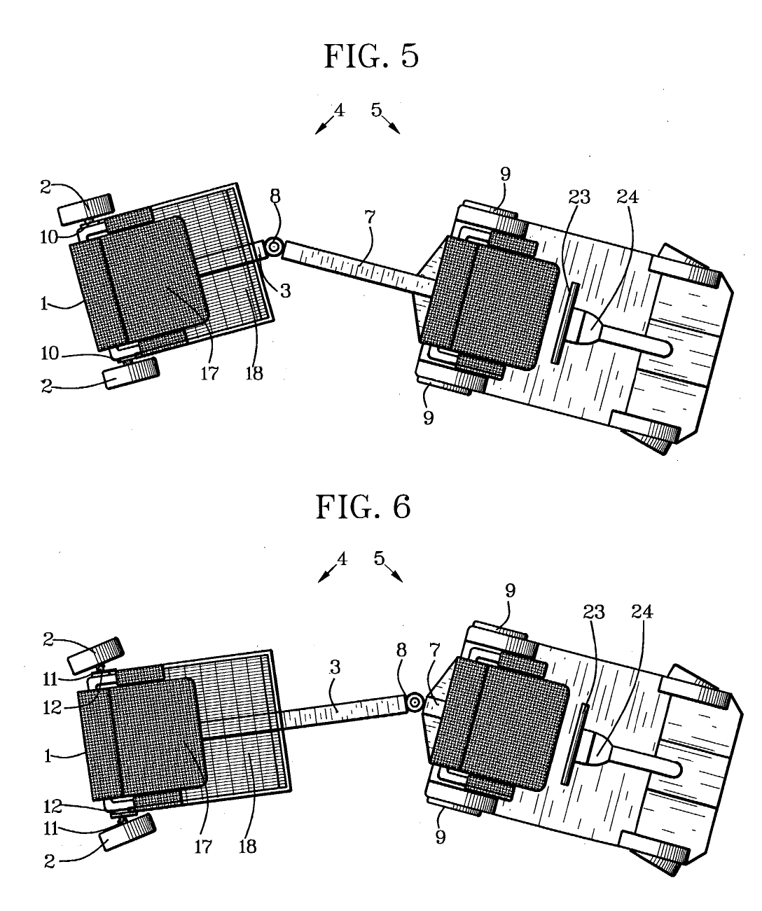

As shown in FIG. 5, with the trailer wheels 2 rotational on axles that include the fixed axles 10 having fixed perpendicularity to an axis of the trailer tongue 3, the tow-directional distance of the first coupling member 6 from the trailer side of the rear wheels 9 of the motorized wheel chair 5 can be predeterminedly longer than the tow-follower distance of the second coupling member 8 from the motorized-wheelchair side of the axis of the trailer wheels 2 for turn-opposite-directional following of rear wheels 9 by the trailer wheels 2 predeterminedly. This will cause the trailer chassis 1 to encounter objects the motorized wheelchair 5 does not encounter on a side opposite to a turn side.

Referring to FIGS. 6-12, the trailer wheels 2 can be rotational on axles that include steerable axles 11 which are pivotal horizontally on chassis pivot bases 12 by a steering pivoter 13. The tow-directional distance of the first coupling member 6 from the trailer side of the rear wheels 9 of the motorized wheel chair 5 can be predeterminedly shorter than the tow-follower distance of the second coupling member 8 from the motorized-wheelchair side of the axis of the trailer wheels 2 for turn-directional following of rear wheels 9 by the trailer wheels 2 as steerable from-side-to-side of the turn-directional following of the rear wheels 9 with the steering pivoter 13 as shown in FIG. 6. This allows steering of the trailer chassis 1 separately from steering of the motorized wheelchair 5 for missing turn-side objects without short-cutting.

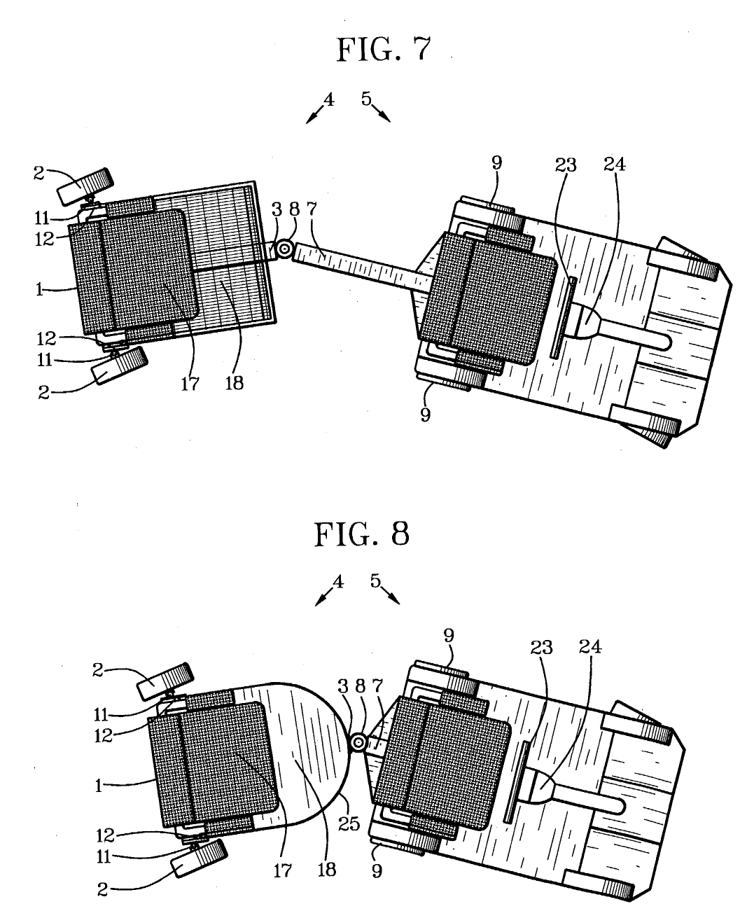

As shown in FIGS. 7 and 10 with the trailer wheels 2 rotational on axles that include the steerable axles 11 which are pivotal horizontally on the chassis pivot bases 12 by a steering pivoter 13, the tow-directional distance of the first coupling member 6 from the trailer side of the rear wheels 9 of the motorized wheel chair 5 can be approximately equal to the tow-follower distance of the second coupling member 8 from the motorized-wheelchair side of the axis of the trailer wheels 2 for approximately direct following of the rear wheels 9 by the trailer wheels 2 as steerable from-side-to-side of the direct following of the rear wheels 9 with the steering pivoter 13. This provides more yet safety from encountering objects not encountered by the motorized wheelchair 5 in turns.

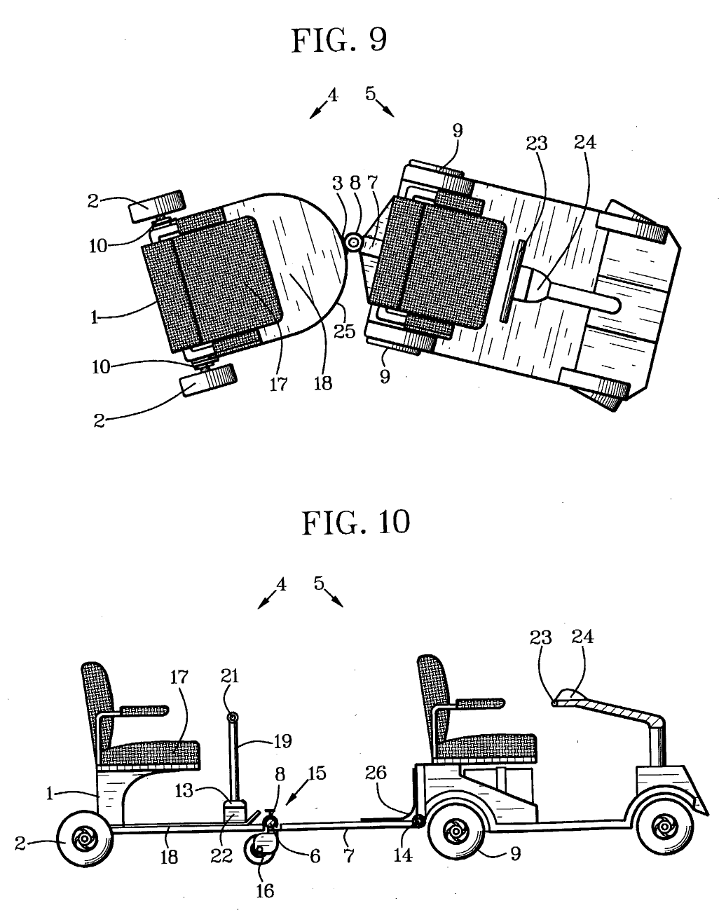

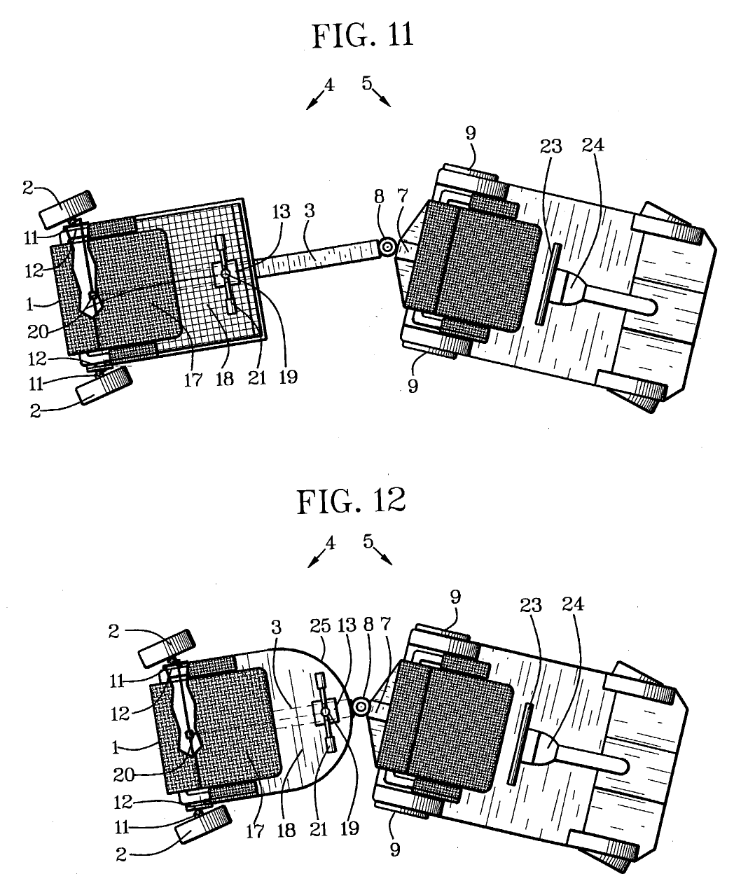

The trailer chassis 1 can include an arcuate front 25 for allowing shortness of the trailer chassis without danger of pinching passenger legs and items intermediate the trailer chassis 1 and the motorized wheelchair 5 on turns, whether with the trailer wheels 2 having the fixed axles 10 as shown in FIGS. 8 and 12 or having the steerable axles 11 as shown in FIG. 9.

As shown in FIG. 10, the tow bar 7 can include a vertically pivotal connector 14 for vertically pivotal attachment of the tow bar 7 to the rear portion of the motorized wheelchair 5. The first coupling member 6 and the second coupling member 8 therefore can include a hitch coupling 15 for coupling of the trailer tongue 3 to the tow bar 7. With the vertically pivotal connector 14, the hitch coupling 15 preferably includes a coupling caster wheel 16 that is directionally pivotal on a bottom of the hitch coupling 15. Also preferable for use with the vertically pivotal connector 14 are a down-pressure spring 26 and forward positioning of the passenger seat 17 to prevent unwanted raising of the trailer tongue 3 and the tow bar 7 from back force applied accidentally by a passenger.

As shown in FIGS. 10-12, with the trailer wheels 2 being rotational on axles that include the steerable axles 11 that are pivotal horizontally on the chassis pivot bases 12 by the steering pivoter 13, the steering pivoter 13 can include a steering column 19 with a steering handle proximate the passenger seat 17 on the trailer chassis 1 and the steering column 19 can have a steering rod 20 in steering actuation of the steerable axles 11. Preferably, the steering handle includes handlebars 21.

The steering pivoter 13 can include a computer-programmable steering motor 22 that is programmed for actuating the steerable axles 11 in predetermined steering relationship of the trailer chassis 1 to steering of the motorized wheelchair 5. The steering rod 20 can transmit steering actuation to the steerable axles 11 with preferably a tie rod as shown figuratively in FIG. 11 or a rotational rod as shown figuratively in FIG. 12 A steering computer 24 can be attachable to the motorized wheelchair 5 proximate a wheelchair steerer 23 for inputting steering data from the wheelchair steerer 24 to the steering computer 24.

Preferably, the steering computer 24 includes programmable capability for overriding computer-programmed steering commands by actuation of the steering handle or handlebars 21 on the trailer chassis 1.

A new and useful motorized-wheelchair trailer having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A motorized-wheelchair trailer comprising:
a trailer chassis having trailer wheels that are oppositely disposed proximate opposite sides of the trailer chassis;
a trailer tongue that is affixed to the trailer chassis and extended orthogonally from proximate an axis of the trailer wheels;
the trailer tongue being articulated for pulling of the motorized-wheelchair trailer by a predetermined motorized wheelchair;
the motorized-wheelchair trailer having a loaded gross weight that is towable by the motorized wheelchair;
a first coupling member on a tow bar that is attachable to a rear portion of the motorized wheelchair;
a second coupling member that is affixed to a front portion of the trailer tongue;
the first coupling member and the second coupling member being articulated for predeterminedly universal pivotal coupling of the trailer tongue to the tow bar detachably;
the first coupling member being positioned on the tow bar at a tow-directional distance from a trailer side of rear wheels of the motorized wheelchair; and
the second coupling member being positioned on the trailer tongue at a tow-follower distance from a motorized-wheelchair side of the axis of the trailer wheels.

2. The motorized-wheelchair trailer of claim 1 wherein:
the trailer wheels are rotational on axles that include fixed axles having fixed perpendicularity to an axis of the trailer tongue; and
the tow-directional distance of the first coupling member from the trailer side of the rear wheels of the motorized wheel chair is predeterminedly shorter than the tow-follower distance of the second coupling member from the motorized-wheelchair side of the axis of the trailer wheels for turn-directional following of rear wheels by the trailer wheels predetenninedly.

3. The motorized-wheelchair trailer of claim 1 wherein:
the trailer wheels are rotational on axles that include fixed axles having fixed perpendicularity to the axis of the trailer tongue; and
the tow-directional distance of the first coupling member from the trailer side of the rear wheels of the motorized wheel chair is approximately equal to the tow-follower distance of the second coupling member from the motorized-wheelchair side of the axis of the trailer wheels for approximately direct following of the rear wheels by the trailer wheels.

4. The motorized-wheelchair trailer of claim 1 wherein:
the trailer wheels are rotational on axles that include the fixed axles having fixed perpendicularity to an axis of the trailer tongue; and
the tow-directional distance of the first coupling member from the trailer side of the rear of the motorized wheel chair is predeterminedly longer than the tow-follower distance of the second coupling member from the motorized-wheelchair side of the axis of the trailer wheels for turn-opposite-directional following of rear wheels by the trailer wheels predeterminedly.

5. The motorized-wheelchair trailer of claim 1 wherein:
the trailer wheels are rotational on axles that include steerable axles that are pivotal horizontally on chassis pivot bases by a steering pivoter; and
the tow-directional distance of the first coupling member from the trailer side of the rear wheels of the motorized wheel chair is predeterminedly shorter than the tow-follower distance of the second coupling member from the motorized-wheelchair side of the axis of the trailer wheels for turn-directional following of rear wheels by the trailer wheels as steerable from-side-to-side of the turn-directional following of the rear wheels with the steering pivoter.

6. The motorized-wheelchair trailer of claim 1 wherein:
the trailer wheels are rotational on axles that include the steerable axles that are pivotal horizontally on the chassis pivot bases by a steering pivoter; and
the tow-directional distance of the first coupling member from the trailer side of the rear wheels of the motorized wheel chair is approximately equal to the tow-follower distance of the second coupling member from the motorized-wheelchair side of the axis of the trailer wheels for approximately direct following of the rear wheels by the trailer wheels as steerable from-side-to-side of the direct following of the rear wheels with the steering pivoter.

7. The motorized-wheelchair trailer of claim 6 wherein:
the tow bar includes a vertically pivotal connector for vertically pivotal attachment of the tow bar to the rear portion of the motorized wheelchair;
the first coupling member and the second coupling member include a hitch coupling for coupling of the trailer tongue to the tow bar; and
the hitch coupling includes a coupling caster wheel that is directionally pivotal on a bottom of a hitch coupling.

8. The motorized-wheelchair trailer of claim 3 wherein:
the tow bar 7 includes a vertically pivotal connector for vertically pivotal attachment of the tow bar to the rear portion of the motorized wheelchair;
the first coupling member and the second coupling member include a hitch coupling for coupling of the trailer tongue to the tow bar; and
the hitch coupling includes a coupling caster wheel that is directionally pivotal on a bottom of a hitch coupling.

9. The motorized-wheelchair trailer of claim 1 wherein:
the trailer chassis includes an arcuate front for allowing shortness of the trailer chassis without danger of pinching passenger legs and items intermediate the trailer chassis and the motorized wheelchair on turns.

10. A motorized-wheelchair trailer comprising:
a trailer chassis having trailer wheels that are oppositely disposed proximate opposite sides of the trailer chassis;
a passenger seat and foot support on the trailer chassis;
the trailer chassis being articulated for carrying a passenger and cargo having a gross weight of the trailer chassis, the passenger and the cargo selectively which is towable by the motorized wheelchair;
a trailer tongue that is affixed to the trailer chassis and extended orthogonally from proximate an axis of the trailer wheels;
the trailer tongue being articulated for pulling of the motorized-wheelchair trailer by a predetermined motorized wheelchair;
a first coupling member on a tow bar that is attachable to a rear portion of the motorized wheelchair;
a second coupling member that is affixed to a front portion of the trailer tongue;
the first coupling member and the second coupling member being articulated for predeterminedly universal pivotal coupling of the trailer tongue to the tow bar detachably;
the first coupling member being positioned on the tow bar at a tow-directional distance from a trailer side of rear wheels of the motorized wheelchair; and
the second coupling member being positioned on the trailer tongue at a tow-follower distance from a motorized-wheelchair side of the axis of the trailer wheels.

11. The motorized-wheelchair trailer of claim 10 wherein:
the trailer wheels are rotational on axles that include fixed axles having fixed perpendicularity to an axis of the trailer tongue; and
the tow-directional distance of the first coupling member from the trailer side of the rear wheels of the motorized wheel chair is predeterminedly shorter than the tow-follower distance of the second coupling member from the motorized-wheelchair side of the axis of the trailer wheels for turn-directional following of rear wheels by the trailer wheels predeterminedly.

12. The motorized-wheelchair trailer of claim 10 wherein:
the trailer wheels are rotational on axles that include fixed axles having fixed perpendicularity to the axis of the trailer tongue; and
the tow-directional distance of the first coupling member from the trailer side of the rear wheels of the motorized wheel chair is approximately equal to the tow-follower distance of the second coupling member from the motorized-wheelchair side of the axis of the trailer wheels for approximately direct following of the rear wheels by the trailer wheels.

13. The motorized-wheelchair trailer of claim 10 wherein:
the trailer wheels are rotational on axles that include the fixed axles having fixed perpendicularity to an axis of the trailer tongue; and
the tow-directional distance of the first coupling member from the trailer side of the rear wheels of the motorized wheel chair is predeterminedly longer than the tow-follower distance of the second coupling member from the motorized-wheelchair side of the axis of the trailer wheels for turn-opposite-directional following of rear wheels by the trailer wheels predeterminedly.

14. The motorized-wheelchair trailer of claim 10 wherein:
the trailer wheels are rotational on axles that include steerable axles that are pivotal horizontally on chassis pivot bases by a steering pivoter on the trailer chassis; and
the tow-directional distance of the first coupling member from the trailer side of the rear wheels of the motorized wheel chair is predeterminedly shorter than the tow-follower distance of the second coupling member from the motorized-wheelchair side of the axis of the trailer wheels for turn-directional following of rear wheels by the trailer wheels as steerable from-side-to-side of the turn-directional following of the rear wheels with the steering pivoter.

15. The motorized-wheelchair trailer of claim 10 wherein:
the trailer wheels are rotational on axles that include the steerable axles that are pivotal horizontally on the chassis pivot bases by a steering pivoter on the trailer chassis; and
the tow-directional distance of the first coupling member from the trailer side of the rear wheels of the motorized wheel chair is approximately equal to the tow-follower distance of the second coupling member from the motorized-wheelchair side of the axis of the trailer wheels for approximately direct following of the rear wheels by the trailer wheels as steerable from-side-to-side of the direct following of the rear wheels with the steering pivoter.

16. The motorized-wheelchair trailer of claim 15 wherein:
the tow bar includes a vertically pivotal connector for vertically pivotal attachment of the tow bar to the rear portion of the motorized wheelchair;
the first coupling member and the second coupling member include a hitch coupling for coupling of the trailer tongue to the tow bar; and
the hitch coupling includes a coupling caster wheel that is directionally pivotal on a bottom of a hitch coupling.

17. The motorized-wheelchair trailer of claim 12 wherein:
the tow bar includes a vertically pivotal connector for vertically pivotal attachment of the tow bar to the rear portion of the motorized wheelchair;
the first coupling member and the second coupling member include a hitch coupling for coupling of the trailer tongue to the tow bar; and
the hitch coupling includes a coupling caster wheel that is directionally pivotal on a bottom of a hitch coupling.

18. A motorized-wheelchair trailer comprising:
a trailer chassis having trailer wheels that are oppositely disposed proximate opposite sides of the trailer chassis;
a passenger seat and foot support on the trailer chassis;
the trailer chassis being articulated for carrying a passenger and cargo having a gross weight of the trailer chassis, the passenger and the cargo selectively which is towable by the motorized wheelchair;
a trailer tongue that is affixed to the trailer chassis and extended orthogonally from proximate an axis of the trailer wheels;
the trailer tongue being articulated for pulling of the motorized-wheelchair trailer by a predetermined motorized wheelchair;
a first coupling member on a tow bar that is attachable to a rear portion of the motorized wheelchair;
a second coupling member that is affixed to a front portion of the trailer tongue;
the first coupling member and the second coupling member being articulated for predeterminedly universal pivotal coupling of the trailer tongue to the tow bar detachably;
the first coupling member being positioned on the tow bar at a tow-directional distance from a trailer side of rear wheels of the motorized wheelchair;
the second coupling member being positioned on the trailer tongue at a tow-follower distance from a motorized-wheelchair side of the axis of the trailer wheels;
the trailer wheels being rotational on axles that include steerable axles that are pivotal horizontally on a chassis pivot bases by a steering pivoter;
the steering pivoter including a steering column with a steering handle proximate the passenger seat on the trailer chassis; and
the steering column having a steering rod in steering actuation of the steerable axles.

19. The motorized-wheelchair trailer of claim 18 wherein:
the steering handle includes handlebars.

20. The motorized-wheelchair trailer of claim 18 wherein:
the steering pivoter includes a computer-programmable steering motor that is programmed for actuating the steerable axles in predetermined steering relationship of the trailer chassis to steering of the motorized wheelchair.

21. The motorized-wheelchair trailer of claim 20 and further comprising:
a steering computer that is attachable to the motorized wheelchair proximate a wheelchair steerer for inputting steering data from the wheelchair steerer to the steering computer.

22. The motorized-wheelchair trailer of claim 20 wherein:
the steering computer includes programmable capability for overriding computer-programmed steering commands by actuation of the steering handle on the trailer chassis.
